(19) United States
(12) Patent Application Publication
(10) Pub. No.: US 2009/0129093 A1
(43) Pub. Date: May 21, 2009

(54) SHADOW-FREE COVE LIGHT

(75) Inventor: Jeremy J. Wittig, Cedarburg, WI (US)

Correspondence Address: BOYLE FREDRICKSON S.C., 840 North Plankinton Avenue, MILWAUKEE, WI, 53203, US

(73) Assignee: SPI Lighting, Inc.

(21) Appl. No.: 11/942,255

(22) Filed: Nov. 19, 2007

(51) Int. Cl. F21V 7/04

(52) U.S. Cl. 362/297

(57) ABSTRACT

A light fixture, particularly adapted for cove lighting, includes an angled reflector assembly that directs light from a fluorescent tube generally toward the back wall of a cove that is above the electrical sockets of the light fixture. The angled reflector assembly is designed such that light is directed from the main illumination portion of the fluorescent tube, rather than from the cool spots of the fluorescent tube. The light fixture reduces dark spot formation in the backlighting of the back wall and therefore provides a relatively even illumination pattern.

### BACKGROUND OF THE INVENTION

The present invention is generally directed to lighting systems and, more particularly, to a light fixture to be used in a recessed manner, such as in an architectural cove, to provide generally shadow-free backlighting of a wall so as to indirectly illuminate a space or room.

In addition to their aesthetic features, architectural coves also provide a recess in which lighting systems may be installed to indirectly illuminate a space, such as a bedroom or hallway. Conventional cove light fixtures are installed either end-to-end in a single row or in a pair of staggered or overlapped rows along or proximate the back wall of the cove.

Cove light fixtures typically use elongated fluorescent tubes as the light source. The tubes are coupled between a pair of sockets to electrically connect the tube to a power source. The sockets are generally in-line with the tube and thus form a non-luminous feature at each end of the light fixture. When arranged end-to-end, the adjacent non-luminous sockets effectively form a gap in the illumination field of the tube. This can create dark spots in the backlighting of the back wall of the cove.

Staggering the light fixtures has been one proposed solution to reduce dark sports and provide a more consistent illumination field. However, staggering the light fixtures is generally considered an inefficient solution. More particularly, to maximize efficiency, the least amount of watts per foot for a desired overall luminosity should be used. Staggering the light fixtures increases the amount of watts that is provided per linear foot. Additionally, for narrow coves, it may be difficult to install the light fixtures in a staggered arrangement.

In another proposed solution, a cove light fixture has been developed that includes an adjustable saw tooth baffle combined with a kicker reflector to reduce socket shadows (dark spots). The saw tooth baffle has a white front edge that diffuses light emitted by the fluorescent tube. The front edge, however, must be adjusted over the life of the fluorescent tube. Additionally, the kicker reflector is installed parallel to the fluorescent tube and is designed to capture the majority of its reflected light from the dim cool spot of the fluorescent tube and direct it toward the shadow area above the electrical socket. The dim cool spot is generally defined by a couple of inches of the fluorescent tube that is adjacent an electrical socket and degrades at a faster rate than the remainder of the fluorescent tube. Thus, the effectiveness of the kicker reflector is reduced over the life of the fluorescent tube.

Therefore, there remains a need to provide an energy efficient solution for reducing dark spot formation in the backlighting of a wall using fluorescent lighting fixtures.

### BRIEF DESCRIPTION OF THE INVENTION

The present inventors have found that that luminosity of conventional fluorescent tubes is sufficient to illuminate the dark spot associated with the non-luminous sockets when the light output of the tube is judiciously directed toward the otherwise dark spot. In this regard, the present invention is directed to a light fixture, particularly adapted for cove lighting, which includes an angled reflector assembly that directs light from the fluorescent tube generally toward the back wall of the cove that is above an electrical socket. The angled reflector assembly is designed such that light is directed, not from the cool spot of the fluorescent tube, but from the main illumination portion of the fluorescent tube. In this regard, the reflector assembly does not need to be adjusted during the life of the fluorescent tube nor is the effectiveness of the reflector assembly affected by the accelerated degradation of the cool spot.

Therefore, it is one object of the present invention to provide a cove lighting fixture that provides a relatively uniform backlighting of a wall absent dark spots typically associated with the electrical sockets.

It is a further object of the invention to provide a reflector assembly for a cove lighting fixture that reflects light from the non-cool spot portions of a fluorescent tube toward the portion of a wall proximate an electrical socket of the lighting fixture.

It is yet another object of the invention to provide a reflector assembly for a cove lighting fixture that can be factory installed without requiring in-field adjustments during the life of the light fixture.

Other objects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout.

In the drawings:

FIG. 1 is top plan view of a portion of space having an architectural cove in which lighting fixtures according to the present invention have been installed;

FIG. 2 is a section view of a representative lighting fixture taken along line 2-2 of FIG. 1;

FIG. 3 is an isometric view of a representative lighting fixture according to one aspect of the present invention;

FIG. 4 is a partial isometric view of two lighting fixtures, similar in construction to that shown in FIG. 3, installed in-line in an end-to-end arrangement;

FIG. 5 is a schematic representation of an illumination pattern provided by a conventional cove lighting fixture arrangement; and

FIG. 6 is a schematic representation of an illumination pattern provided by a cove lighting fixture arrangement comprised of lighting fixtures similar to that shown in FIGS. 3-4.

### DETAILED DESCRIPTION OF THE INVENTION

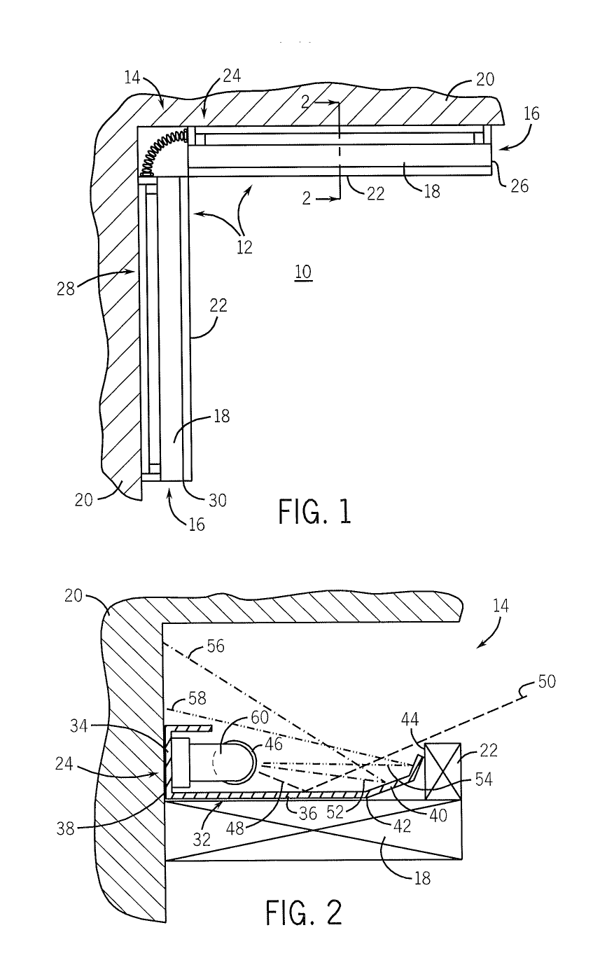

The present invention will be described with respect to light fixtures having elongated light tubes and arranged in a linear fashion to illuminate a room 10. In one preferred embodiment, the light fixtures, collectively designated 12, are positioned in an architectural cove 14, partially shown in FIG. 1, formed above the space or room 10 to be illuminated. As well-known in the art, in addition to the aesthetics that an architectural cove 14 may provide, the cove 14 provides a recess 16 in which the light fixtures 12 can be positioned and thus hidden from view. The architectural cove 14 is generally defined by a floor 18 that supports a back wall 20 and a front wall 22. The front wall 22 has a height less than the back wall 20 and thus allows light illuminated from the fixtures 12 to exit the recess 16 and provide indirect and diffused lighting of the room 10.

The light fixtures 12 are arranged, in a preferred implementation, so as to be positioned against the back wall 20. Positioning of the fixtures 12 in proximity to the back wall 20 reduces shadow and hot spot formation on the back wall 20. Additionally, the fixtures 12 are preferably installed such that the top of the fixtures 12 is slightly below the line-of-sight over the front wall 22. This allows for the maximum amount of light output into the room 10 while maintaining the light fixtures 12 hidden from view.

To further reduce the formation of shadows and hot spots on the back wall 20, the light fixtures 12 are arranged in a linear fashion and end-to-end. Thus, for example, light fixture 24 should be positioned in line with and abut another light fixture (not shown) at end 26. Similarly, light fixture 28 is in-line with and abuts another light fixture (not shown) at end 30.

Referring now to FIG. 2, a sectional view of a representative light fixture is shown. For purposes of illustration, light fixture 24 will be described, but it is understood that each of the light fixtures is similarly constructed. Light fixture 24 includes a primary reflector 32 that includes a vertical surface 34 that abuts against back wall 20. A horizontal surface 36 extends from a bottom end 38 of the vertical surface 34 and runs along the floor 18 of the cove 14. The primary reflector 32 further includes a doubly-angled surface 40 that extends from the end 42 of the horizontal surface 36 and extends generally toward the interior surface 44 of front wall 22.

In a preferred embodiment, the vertical, horizontal, and doubly-angled surfaces are composed of reflective material, such as a reflective material laminate or reflective material paint. The use of such reflective material for redirecting light from a light source, such as a fluorescent tube, is well-known in the art.

The light fixture 24 further includes an elongated lamp 46, such as fluorescent tube, that emits light along multiple light paths at various angles to the primary reflector 32. Some of the light paths are angled toward the horizontal and angled surfaces 36, 40. For example, light path 48 is redirected by the horizontal surface 36 along path 50 and into the room 10. Light paths 52, 54, on the other hand, are redirected by the angled surface 40 along paths 56, 58, respectively, and against the back wall 20. The light fixture 24 further includes an electrical socket 60 that in conventional cove lighting fixtures, as described above, results in shadows along the back wall generally above the socket 60. The present invention, however, overcomes this drawback of conventional light fixtures using additional (secondary) reflectors, as will be described in greater detail below. As will be described, in one embodiment, the secondary reflectors are fastened to the primary reflector. In an alternate embodiment, the secondary reflectors are constructed from or otherwise integrally formed with the primary reflector 32.

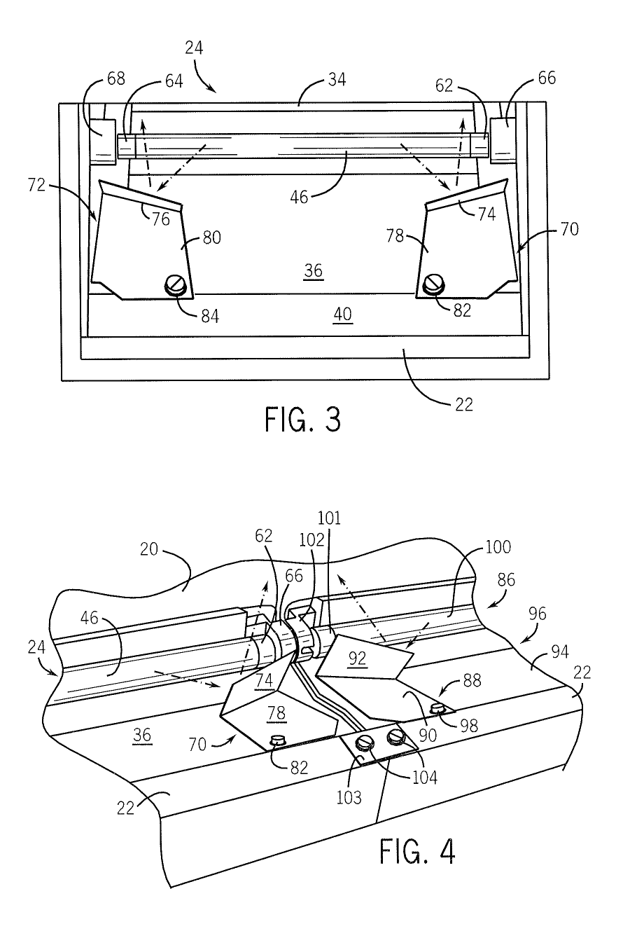

As shown in FIG. 3, elongated lamp 46 extends parallel to the length of the vertical surface 34 between a pair of electrical sockets 66, 68. Each electrical socket is mounted to the vertical surface 34 or any other surface. The electrical sockets provide connection points for securing the lamp 46 to the light fixture 24, as is well-known. Specifically, each end of the elongated lamp 46 includes a pin 62, 64 that engages respective sockets 66, 68. The light fixture 24 further includes secondary reflectors 70, 72 respectively coupled proximate sockets 66, 68. Each secondary reflector 70, 72 includes an angled plate 74, 76 extending from a body member 78, 80. The body members 78, 80 are coupled to the horizontal surface 36 of the primary reflector 32 or any other surface using fasteners, such as 82, 84. In one embodiment, each body member may be machined to form holes that align with tabs extending from the horizontal surface. In this embodiment, each primary reflector 32 could be attached to the light fixture by aligning the holes in the body member with the tabs and press-fitting the reflector against the horizontal surface or any other surface. The angled plates 74, 76 are oriented such that light is reflected in the general direction above the sockets 66, 68.

The light fixtures 12 are designed to be arranged end-to-end, such as illustrated in FIG. 4. For example, light fixtures 24 and 86 are arranged in-line with one another such that secondary reflector 70 is proximate secondary reflector 88 of light fixture 86. Secondary reflector 88 is similar in construction to secondary reflector 70. Specifically, secondary reflector 88 has a reflector body 90 with an angled reflector plate 92 extending therefrom. The secondary reflector 88 is secured to the horizontal surface 94 of primary reflector 96 using fastener 98. The secondary reflectors 70, 88 cooperate to direct light from respectively associated lamps 46, 100 to illuminate the dark spot associated with the electrical sockets 66, 102. Only one pin 62, 101 for lamps 46, 100, respectively, are shown but it is understood that opposite ends of the lamps 46, 100 also include pin that engage respective sockets. To reduce the gap between adjacent light fixtures and help maintain the linearity of the arrangement, adjacent fixtures may be coupled to one another using a linking bracket 103 and conventional fasteners 104, such as mounting bolts.

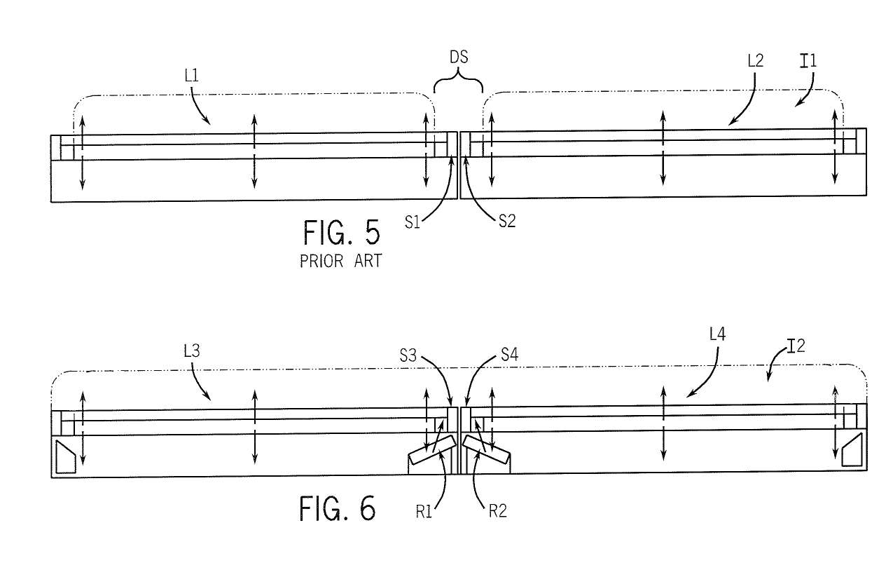

Referring now to FIG. 5, as referenced above, conventional light fixtures, designated L1, L2, when arranged end-to-end, create a dark spot, designated DS, above the adjacent electrical sockets, designated S1, S2, in the combined illumination field, I1, of the fixtures. Light fixtures according to the present invention, generally designated L3, L4, include reflectors, generally designated R1, R2 that, as shown in FIG. 6, provide illumination of the otherwise dark spot adjacent sockets S3, S4 to provide a uniform illumination field, 12. In this regard, the present invention provides more consistent backlighting of the back wall 20 than conventional lighting fixtures.

In a preferred embodiment, each primary reflector 32 is made from a single sheet of reflective material, e.g., metal, using known fabrication techniques. It is contemplated however that the primary reflectors could be formed from multiple sheets of reflective material and then joined together in a conventional manner, e.g., welding. Additionally, to provide a consistent lamination pattern, it is preferred that the reflectors, both primary and secondary, for adjacent light fixtures have similar reflectance characteristics; however, the invention is not so limited.

Many changes and modifications could be made to the invention without departing from the spirit thereof. The scope of these changes will become apparent from the appended claims.

I claim:

1. A light fixture assembly comprising:
a mounting member adapted to be mounted to a surface and providing a socket;
a light source connected to the socket,
a first reflector that reflects light emitted by the light source to backlight the surface, wherein the socket creates a dark spot associated with the socket in the backlighting of the surface; and
a second reflector that reflects light emitted by the light source to illuminate the dark spot.

2. The light fixture assembly of claim 1 wherein the light source is a fluorescent tube that has a length extending along an axis that is parallel to the surface and wherein the second reflector is angled relative to the axis.

3. The light fixture assembly of claim 1 wherein the second reflector has a first planar portion and a second planar portion that extends at angle from the first planar portion.

4. The light fixture assembly of claim 3 wherein the first planar portion is flush mounted to the first reflector such that the second reflector portion extends away from the first reflector.

5. The light fixture assembly of claim 1 wherein the first reflector and the second reflector are constructed to provide approximately equal reflectance.

6. The light fixture assembly of claim 1 wherein the first reflector has a length generally equal to that of the light source and the second reflector is coupled to the first reflector such that a total length of the first reflector and the second reflector exceeds that of the light source.

7. A recessed lighting assembly for backlighting a planar surface, the assembly comprising:
a lamp;
a mounting bracket adapted to be mounted to the planar surface;
a pair of electrical sockets connected to the mounting bracket and adapted to engage respective ends of the lamp;
a planar reflector plate connected to the mounting bracket and adapted to reflect light emitted by the lamp toward the planar surface; and
a pair of angled reflector plates each of which is connected to the mounting bracket and associated with a respective one of the pair of electrical sockets, each of reflector plates adapted to redirect light emitted by the lamp toward a portion of the planar surface proximate an associated electrical socket.

8. The recessed lighting assembly of claim 7 wherein each angled reflector plate has a first angled portion and a second angled portion different from the first angled portion.

9. The recessed light assembly of claim 7 wherein the lamp is a fluorescent tube.

10. The recessed light assembly of claim 9 wherein the fluorescent tube comprises a first end having a first connector and a second end having a second connector, the first end and the second end spaced from one another by a tube chamber, and wherein the first connector and the second connector engage with the pair of electrical sockets when the fluorescent tube is coupled to the mounting bracket.

11. The recessed light assembly of claim 10 wherein the tube chamber has a length and the planar reflector plate has a length equal to the length of the tube chamber.

12. The recessed light assembly of claim 11 wherein the pair of angled reflector plates are coupled to respective ends of the planar reflector plate.

13. The recessed light assembly of claim 12 wherein a total length of the planar reflector plate and the pair of angled reflector plates is greater than the length of the tube chamber.

14. A recessed light system comprising:
first and second light fixtures mounted on a planar surface, the first light fixture having a first light source and a first non-luminous socket, and the second light fixture having a second light source and a second non-luminous socket, and wherein the first and second light fixtures are adapted to be installed in an end-to-end arrangement such that the first non-luminous socket is adjacent the second non-luminous socket; and
first and second reflectors associated with the first and second light fixtures, the first reflector associated with the first light fixture and adapted to direct light emitted by the first light source to a first portion of the planar surface proximate the first non-luminous socket and the second reflector associated with the second light fixture and adapted to direct light emitted by the second light source to a second portion of the planar surface proximate the second non-luminous socket.

15. The system of claim 14 wherein each reflector includes an angled reflector plate.

16. The system of claim 15 wherein the angled reflector plate of the first reflector is symmetrically oriented with respect to the angled reflector plate of the second reflector.

17. The system of claim 14 wherein each reflector is constructed to provide equal reflectance.

18. The system of claim 17 wherein each reflector plate is formed from a single sheet of reflective material.

19. The system of claim 14 wherein the first and second light fixtures are designed to be mounted in a cove portion of an architectural stricture.

20. The system of claim 14 wherein the first light source and the second light source are each a fluorescent tube.
